(19) United States
(12) Patent Application Publication
(10) Pub. No.: US 2005/0148392 A1
(43) Pub. Date: Jul. 7, 2005

(54) System and method for configuring the system to provide multiple touchscreen inputs

(75) Inventors: Emilio Martinez, Laredo, TX (US); Stephen J. Garza, San Antonio, TX (US)

Correspondence Address: CAHN & SAMUELS LLP, 2000 P STREET NW, SUITE 200, WASHINGTON, DC, 20036, US

(73) Assignee: Hypertek Simulations, Inc., Laredo, TX (US)

(21) Appl. No.: 10/993,123

(22) Filed: Nov. 22, 2004

Related U.S. Application Data
(60) Provisional application No. 60/523,699, filed on Nov. 21, 2003.

(51) Int. Cl. A63F 13/00

(52) U.S. Cl. 463/42

(57) ABSTRACT

The present invention preferably includes a system and method for allowing a plurality of input stations such as touchscreen input devices, for example, to simultaneously provide input to a central processing unit executing a computerized simulation program such as a game simulation program. The invention allows a plurality of input groups, for example, to be received by the central processing unit. Each received input group preferably causes a graphical effect on a parameter or function provided by the simulation program. Each graphical effect is preferably displayed on a corresponding computer monitor, for example, thereby allowing a first participant to view a first graphical effect and a second participant to view a second graphical effect. The system can allow participants exercising control over the touchscreen input devices to experience a more real “feel” of the game, that is, a feeling as though the participant were participating in the real-life scenario emulated by the simulation program.

This application claims the benefit of U.S. provisional application Ser. No. 60/523,699, filed on Nov. 21, 2003, which is incorporated herein by reference.

### I. FIELD OF THE INVENTION

The present invention relates generally to interactive computerized simulations, and more particularly to an interactive computerized simulation allowing a plurality of users to participate in the simulation as a team.

### II. BACKGROUND OF THE INVENTION

Perhaps, one of the most exciting and powerful features that can be provided by a computer system is computerized simulation. For example, a variety of simulation programs exist including simulation programs for spacecraft, sporting games, and education. Regardless of the type of simulator, however, the overall purpose is to emulate a real-life situation. Some game simulation programs, for example, simulate real-life situations involving team effort.

Although the real-life situations emulated by a game simulation program may involve team effort, heretofore, the game simulation program did not allow a group of participants to interact with the simulation program as a team. In a computerized battleship game simulation program, for example, a sole human typically interacts with the game simulation program alone by controlling the battleship's operations. In a football game simulation program, for example, a sole human participant typically interacts with the game simulation program alone by controlling a specified member of the game participant's team, for example, the quarterback. Enjoyment of these types of simulation programs are often diminished due to a variety of problems.

One of the primary problems encountered in such an approach relates to the overall purpose of having a simulation program. In continuing with the battleship example offered above, a battleship typically has a plurality of functions that should be performed, many of which are typically performed by separate designated crew members. Thus, in the battleship simulation program identified above, if only one participant is interacting with the simulation program, the real-life feel can be diminished. Similarly, football is a team sport. Therefore, the life-like feel of the game can be diminished when only a sole participant can interact with the game simulation program. Although an observer may be observing the participant as he or she interacts with the simulation program and offer words of advice on how to best control the battleship, for example, heretofore, the observer could not interact with the simulation program.

Another problem is that in attempting to provide the best life-like feel, the game simulation program often includes all or most of the actual functions or features included in the real-life situation. As a result, the participant may become overwhelmed. In addition, in some situations, the participant may have a favorite function of the simulation program that he or she likes to control. The participant may therefore neglect control of the other functions, thereby causing the participant to fail in accomplishing the overall mission of the simulation program.

In light of the foregoing, what is needed is a computer system and method for configuring the system to provide a plurality of inputs to be provided by multiple participants interacting with a simulation program executed on the computer system as a team.

### III. SUMMARY OF THE INVENTION

The present invention includes a system and method for allowing a plurality of input stations such as touchscreen input devices, for example, to simultaneously provide input to a central processing unit executing a simulation program such as a game simulation program. The invention allows a plurality of input command groups, for example, to be received by the central processing unit. Each received input command group preferably causes a graphical effect on a parameter or function provided by the simulation program. The system can allow participants exercising control over the touchscreen input devices to experience a more life-like feel of the game, that is, a feeling as though the participants were participating in the real-life scenario emulated by the simulation program.

In at least one embodiment, the invention includes a computer system executing a computerized simulation program for allowing at least two participants to interact with the simulation program as a team with an overall common team goal. In such an embodiment, the invention further includes a plurality of touchscreen input devices wherein each device provides at least one corresponding group of input commands to the system; a controller system communicatively coupled to each of the touchscreen input devices wherein the controller system includes a central processing unit for executing the simulation program and for accepting each group of input commands to allow each group of input commands to have a graphical effect on a parameter or element provided by the simulation program; a plurality of video output devices wherein each of the video output devices is communicatively coupled to the controller system and corresponds to a particular touchscreen input device wherein each of the video output devices displays output represented by a graphical effect on a parameter caused by a group of input commands; and a multiple touchscreen input device-video output device driver module executed on the server computer for allowing the groups of input commands to be accepted by the central processing unit.

Given the following enabling description of the drawings, the apparatus should become evident to a person of ordinary skill in the art.

### IV. BRIEF DESCRIPTION OF THE DRAWINGS

FIG. 1 illustrates an exemplary system of the invention according to at least one embodiment of the invention.

FIG. 2A illustrates the touchscreen input devices of FIG. 1 and their respective corresponding groups of input commands according to at least one embodiment of the invention.

FIGS. 2B-2F illustrate graphical screen content of the touchscreen input devices of FIG. 1 according to at least one embodiment of the invention.

FIG. 3A illustrates the video output devices of FIG. 1 and their respective corresponding parameters according to at least one embodiment of the invention.

FIG. 3B illustrates a configuration graphical user interface (GUI) in which the video output devices of FIG. 1 are configured.

FIG. 4 illustrates an exemplary method for configuring the system of FIG. 1 according to at least one embodiment of the invention.

FIG. 5 illustrates an exemplary method performed by a multiple-touchscreen input device-video output device driver module executed by the central processing unit of the system according to at least one embodiment of the invention.

FIG. 6 illustrates an exemplary method performed by step 510 of the exemplary method depicted in FIG. 5.

### V. DETAILED DESCRIPTION OF THE DRAWINGS

The present invention preferably includes a system and method for allowing a plurality of input stations such as touchscreen input devices, for example, to simultaneously provide input to a controller system including a central processing unit for executing a simulation program such as a game simulation program. The multiple input feature of the invention allows each user of one of the plurality of touchscreen input devices to interact with the simulation program and participate in the game as a team, with each participant being responsible for at least one parameter or function. For example, in at least one embodiment, the participant may be responsible for the duties of a crew aboard a spaceship, provided by the simulation program. As a result, the participants can experience a life-like feeling and experience the very scenario that the simulation program imitates.

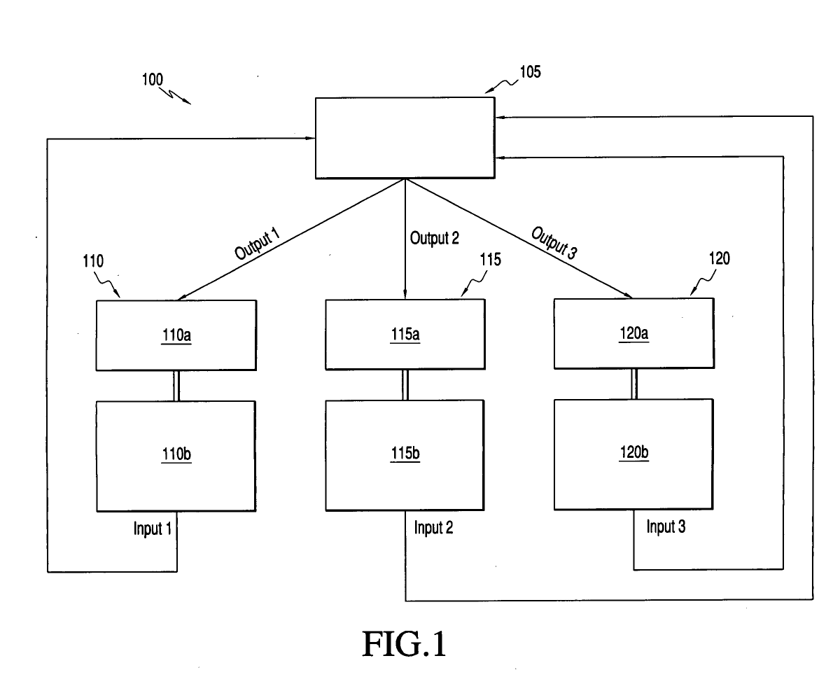

Referring now to FIG. 1, the illustrated exemplary system of the present invention preferably includes a controller system 105, a user station 110, a user station 115, and a user station 120. It should be noted that the invention may employ fewer or additional user stations in accordance with a desired embodiment.

In at least one embodiment, the controller system 105 includes a computer central processing unit (CPU) with at least a 2.0 Gigahertz (GHZ) clockspeed. The controller system 105 also preferably includes at least one megabyte of random access memory (RAM). In addition, the controller system 105 preferably includes at least two, for example, 256 megabyte video cards, for example, one card for each attached video output device. After being presented with the disclosure herein, those of ordinary skill in the relevant art will realize that a variety of other optional peripherals can be attached to the system 100 for increased communications. For example, in at least one embodiment, a surround sound speaker system including a surround sound sound card is attached to the system for increased enjoyment of the simulation program executed by the controller system 105.

As used herein, the term “user station” refers to a combination of a touchscreen input device and a corresponding video output device. Each input device is preferably indirectly communicatively coupled to a corresponding output device via the controller system 105. For example, the touchscreen input device 110b corresponds to video output device 110a, and input from input device 110b is transmitted to the controller system 105. The controller system 105 produces the output resulting from the input from the input device 110b and provides the output to the corresponding video output device 110a, as will be described herein in more detail below.

In at least one embodiment, each touchscreen input device, for example, the touchscreen input device 110b, is a touchscreen video display device attached via the controller system 105's Universal Serial Bus (USB) port and includes Magic Touch® technology, produced by Keytech, Inc. of Richardson, Tex. In at least one embodiment, the Magic Touch® technology displays a graphical virtual keyboard on the input device 110b, for example. In addition, the Magic Touch® technology preferably displays a graphical element on the input device 110b which can be activated or deactivated, for example, a virtual button that graphically emulates a real button, in at least one embodiment of the invention.

Each input device preferably also includes computer software for transmitting input to the simulation, as will be described in more detail herein below. For example, in at least one embodiment, Mount Focus software, manufactured by Mount Focus Information Systems, LLC., located in Wilmington, Del., serves as the computer software for each touchscreen input device.

As shown in FIG. 1, in at least one embodiment, each video output device of a user station, for example, the output device 110a, is a computer monitor and provides output for a corresponding video output device, as will be described herein in more detail below. For example, a 17″ flat-screen Samsung Syncmaster model 710V computer monitor, manufactured by Samsung Electronics Co. Ltd., of Seoul, Korea may be used. After being presented with the disclosure herein, those of ordinary skill in the relevant art will realize that a variety of other types of computer monitors may be employed with the present invention. For example, a standard 17″ computer display monitor manufactured by Dell computer corporation, of Austin, Tex. may be employed by the invention in at least one embodiment. In the system illustrated in FIG. 1, a second video adapter for supporting multiple monitors is preferably installed in a port of the controller system 105. Alternatively, a standard video adapter can be upgraded with an adapter that is capable of connecting directly to a plurality of computer monitors, for example. Communication of the system 100 will now be described.

Each of the plurality of touchscreen input devices shown in FIG. 1 is preferably communicatively coupled to the controller system 105 and provides input signals to the CPU included within the controller system 105. Thus, input device 110b provides an input signal, for example, input signal 1 as shown in FIG. 1, to the CPU. Likewise, the input device 115b provides an input signal, for example, input signal 2 as shown in FIG. 1, to the CPU, and input device 120b, for example, provides an input signal, for example, input signal 3 as shown in FIG. 1.

Similar to the communication described above for the touchscreen input devices, each of the plurality of video output devices shown in FIG. 1 is preferably communicatively coupled to the controller system 105. Each output device receives output signals from the CPU included within the controller system 105. Thus, output device 110a displays information included within an output signal, for example, output signal 1 as shown in FIG. 1, from the CPU. Likewise, the output device 115a displays information included within an output signal, for example, output signal 2 as shown in FIG. 1, from the CPU, and output device 120a, for example, displays information included within an output signal, for example, output signal 3 as shown in FIG. 1.

In the embodiment depicted in FIG. 1, a multiple video output device-touchscreen driver module, for example, a computer monitor-touchscreen display device driver module executed on the controller system 105 allows the multiple inputs to be accepted by the system 105 and displayed on their respective video output devices. In at least one embodiment, the multiple monitor-touchscreen display device driver is a driver produced by Keytec, Inc., of Richardson, Tex.

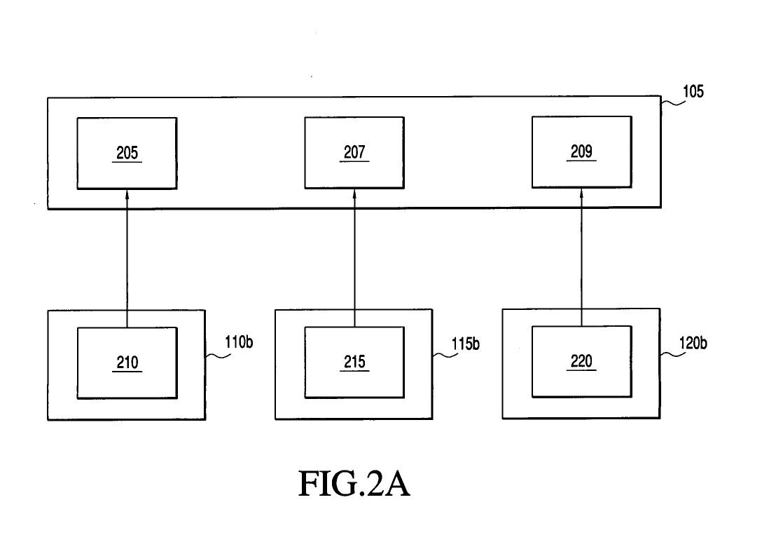

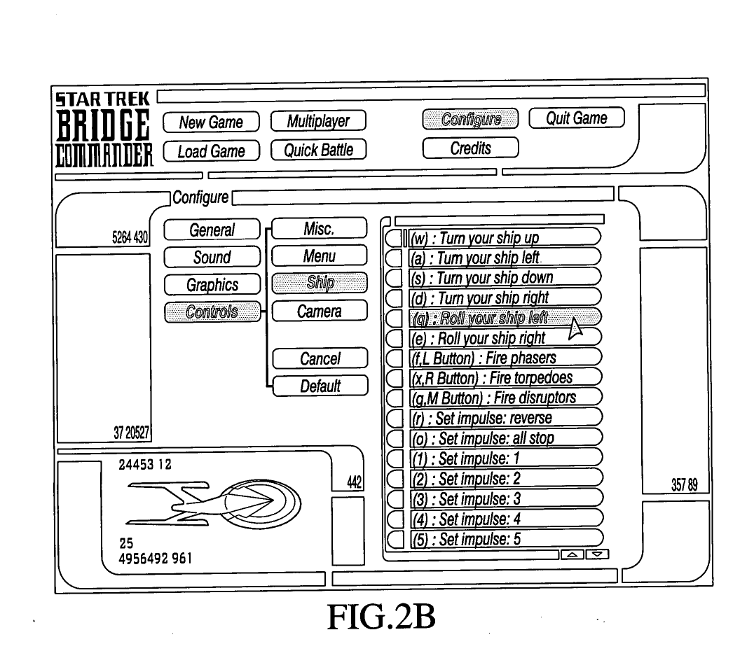

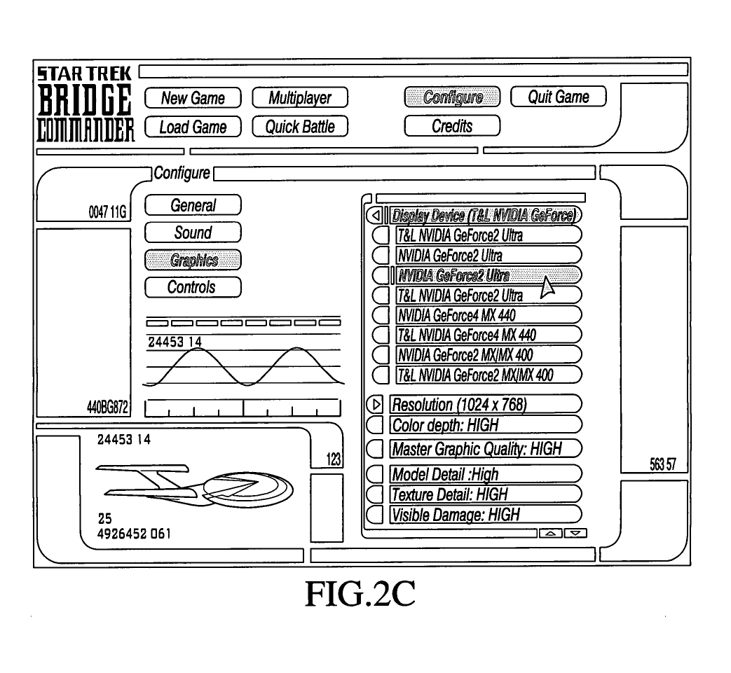

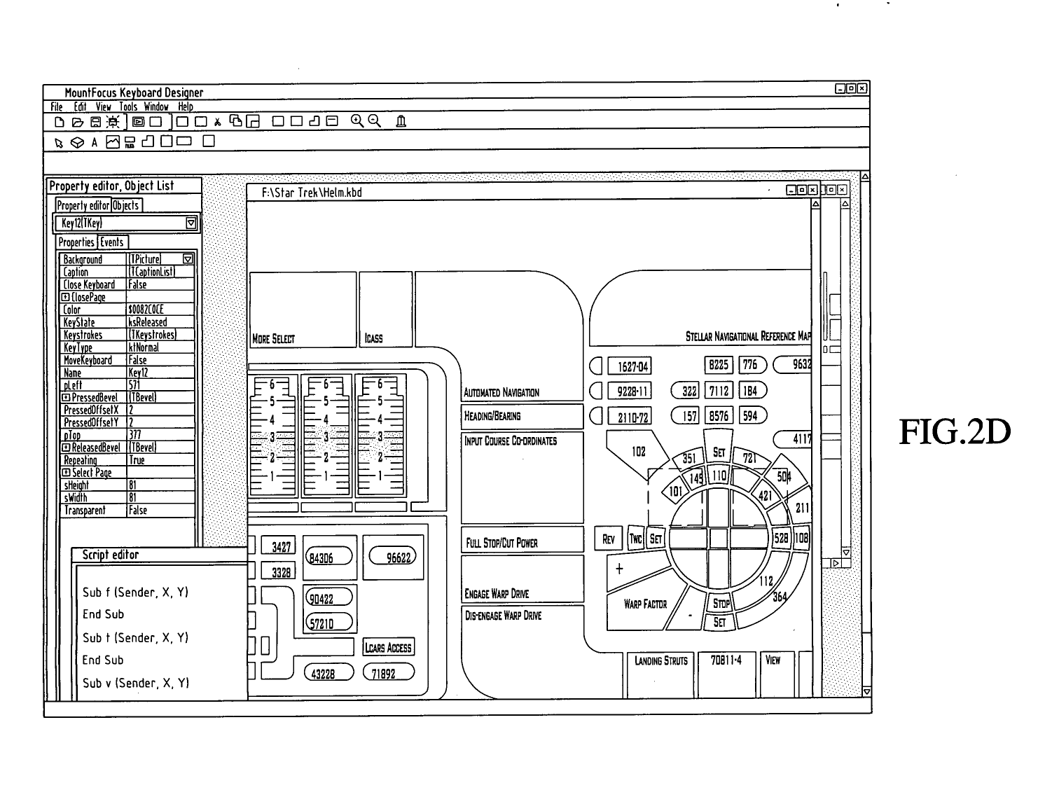

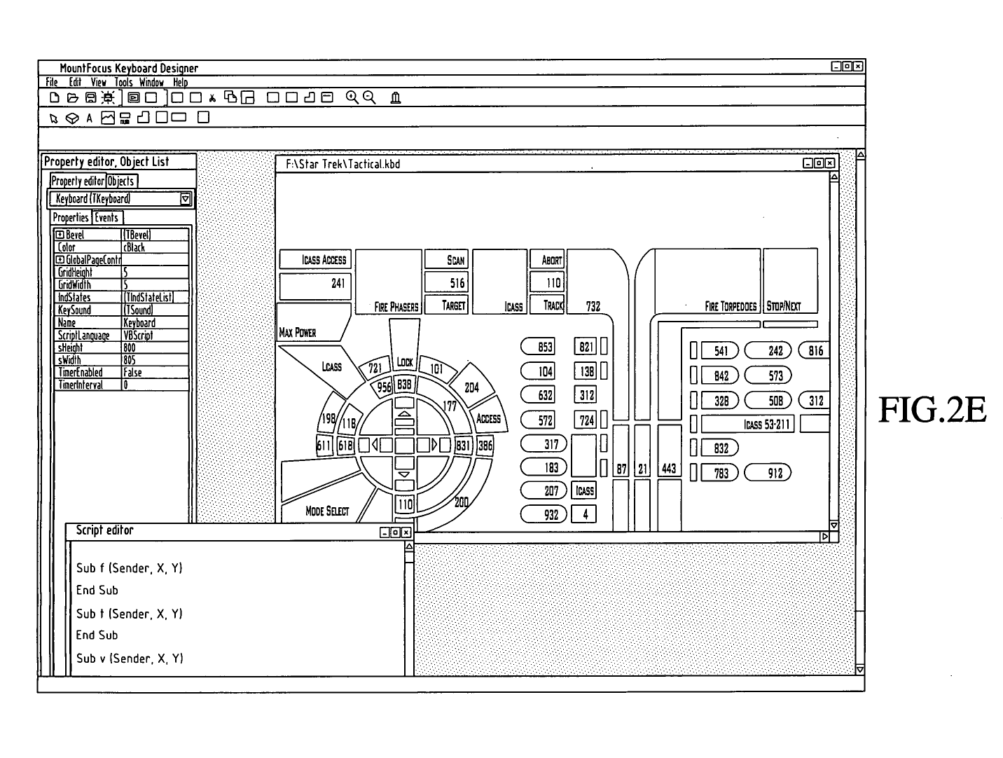

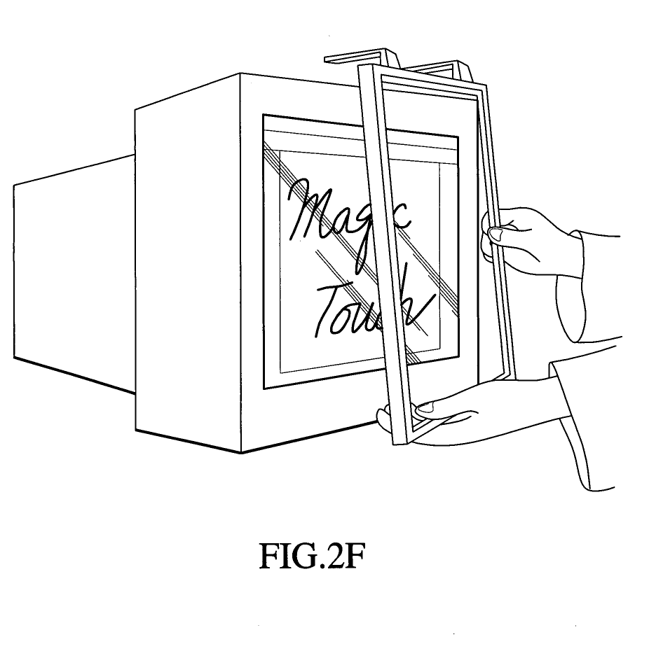

Referring now to FIGS. 1 and 2A, the CPU of the controller system 105 preferably accepts at least one group of input commands included within each input signal shown in FIG. 1. For example, input command group 210, input command group 215, and input command group 220, included within the input signals input 1, input 2, and input 3, respectively, as shown in FIG. 1, each cause a graphical effect on a particular corresponding parameter or element provided by the simulation program.

Referring now to FIG. 2A, for instance, in a spaceship game simulation program scenario, input command group 210 is entered by a user at user station 110 for controlling the bridge of a spaceship, thereby emulating duties of the spaceship's captain and other crew members responsible for navigating the ship. Input command group 215 is entered by a user at user station 115 for controlling the weapons system of the spaceship, thereby emulating the duties performed by the spaceship's weapons crew. Finally, input command group 220 is entered by a user at user station 120 for monitoring progress of the spaceship's overall operation, for example. That is, input command group 220 may be a group of input commands entered by a user for determining how well each of the spaceship's individual operations are proceeding. In the example offered above, the commands included in input command group 220 can be described as a group of commands emulating duties of the spaceship's commander or commanding team.

As shown in FIG. 2A, the simulation program executed by the CPU of the controller system 105 preferably provides multiple controllable parameters, for example, parameter 205, parameter 207, and parameter 209. Each controllable parameter, for example, parameter 205, is allowed to be manipulated or controlled by a corresponding group of input commands, for example, input command group 210.

In continuing with the exemplary spaceship simulation program scenario offered above, in at least one embodiment, the input command group 210, the group of commands for controlling the bridge of the spaceship, allows various elements, functions, and/or features of this parameter, that is, the spaceship's bridge, to be controlled. Similarly, the input command group 215, the group of commands for controlling the weapons system of the spaceship, allows various elements, functions, and/or features (e.g., which cannon to fire, how long to fire, in which direction, etc.) of this parameter, that is, the weapons system, to be controlled. The input command group 220, the group of commands for controlling action of the commander of the spaceship, allows various elements, functions, and/or features of this parameter, that is, action of the commander, to be controlled.

There is preferably a one-to-one correlation between a group of input commands accessible by a user of one of the user stations and a particular corresponding controllable parameter provided by the simulation program. Continuing with the exemplary scenario offered above, however, the user emulating the spaceship's commander, that is, the user at user station 120b of FIG. 1, may determine that the user emulating the spaceship's weapons team, that is, the user at user station 115b, is not performing as well as that user should. As the users have embarked upon an overall mission via a team-oriented approach, the spaceship's commander can decide that the weapons team should be provided assistance from the bridge control team, for example. In such a situation, in addition to having access to the input command group for controlling the bridge control parameter, the bridge control user is given access to the input command group for controlling the weapons system of the spacecraft, thereby allowing the bridge control user to assist the weapons control user.

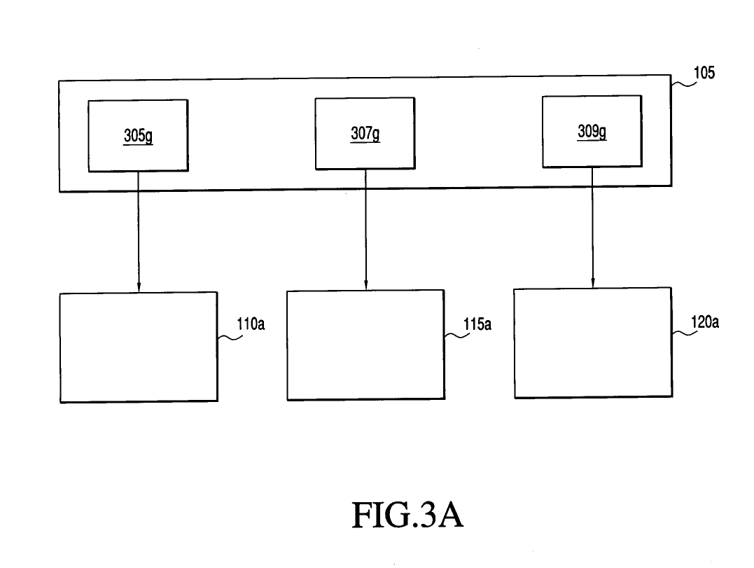

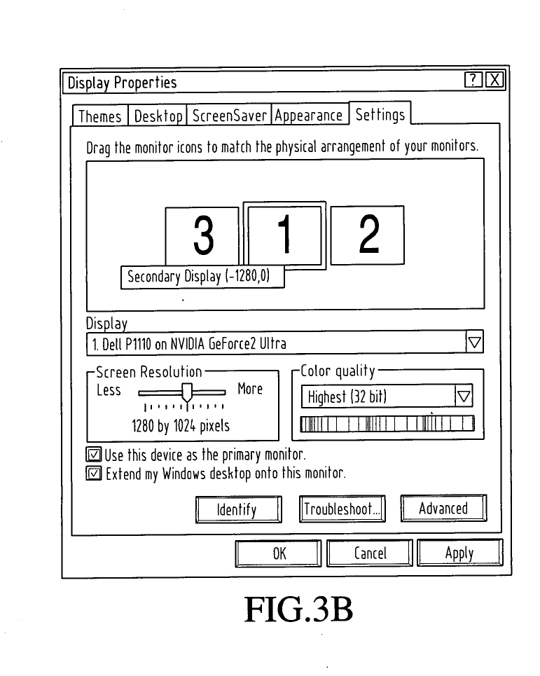

Referring now to FIGS. 1 and 3A, the CPU of the controller system 105 preferably produces a graphical effect, for example, graphical effect 305g, graphical effect 307g, or graphical effect 309g for each received group of input commands for controlling a particular corresponding controllable parameter. Each graphical effect is a representation of the effect of a particular input command group on the input command group's corresponding controllable parameter provided by the simulation program and is preferably transmitted to a video output device via an output signal as shown in FIG. 1, for example.

Referring now to FIG. 3A, in at least one embodiment, the graphical effect 305g is a representation of the effect that the input command group 210 had on its corresponding controllable parameter 205. Similarly, the graphical effect 307g is a representation of the effect that the input command group 215 had on its corresponding controllable parameter 207, and the graphical effect 309g is a representation of the effect that the input command group 220 had on its corresponding controllable parameter 209.

In continuing with the exemplary scenario offered above, the graphical effect 305g may include one of the control gauges in the bridge of the spacecraft changing from a low setting to a high setting, for example, a speed gauge, as a result of the simulation program having received a command in the corresponding command group instructing the spaceship to increase its speed.

Similarly, the graphical effect 307g may include one of the cannons of the spaceship firing a rocket-propelled grenade, as a result of the simulation program having received a command in the corresponding command group instructing the cannon to launch the grenade.

Each graphical effect is displayed on at least one video output device shown in FIG. 1, for example. In the exemplary scenario referenced above, the video output device 110a preferably depicts the control gauge in the spacecraft's bridge changing from the low setting to the high setting. At the same time, the video output device 115 preferably depicts the spaceship's cannon firing the rocket-propelled grenade. Thus, at any given time, a first game participant, for example, a participant stationed at user station 1, is preferably viewing a different graphical scene, that is, a representation of a graphical effect, than a second game participant. It should be noted, however, that in at least one embodiment, a first game participant may be viewing the same or a similar graphical scene as a second game participant. For example, in the scenario identified above where the bridge control participant has taken over or is sharing the weapons control parameter, the bridge control participant may is preferably viewing both a graphical scene in which the cannon is firing and a graphical scene in which the speed control gauge is changing its setting.

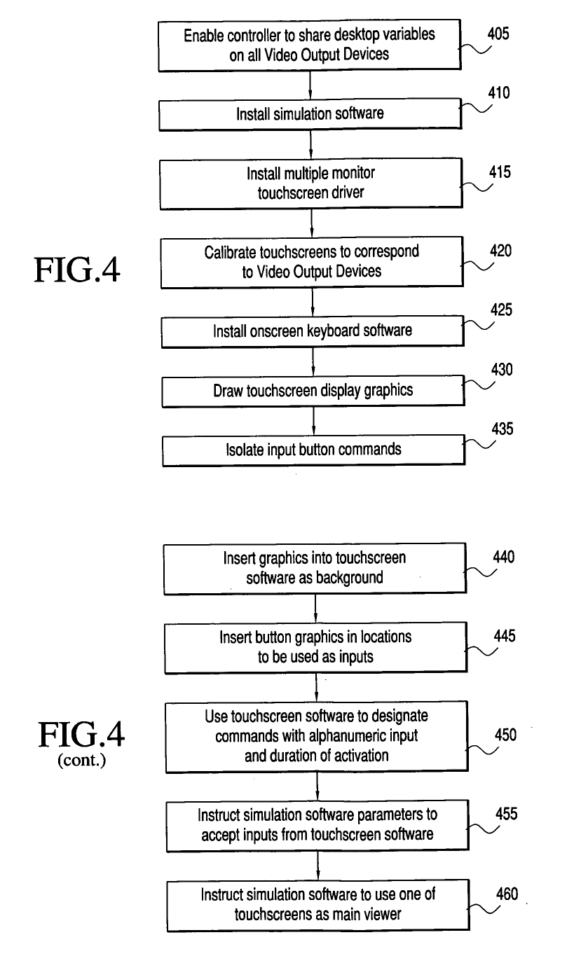

Referring now to FIG. 4, a method for configuring the system 100 shown in FIG. 1 is presented. In step 405, the controller system 105, for example, is enabled to share at least one desktop variable on the video output devices. For example, in at least one embodiment, the controller system 105 is preferably enabled to share a refresh rate such that a refresh rate for one video output device is the same as another video output device. In such a scenario, the video output device 110a, for example, preferably refreshes at the same rate as the video output devices 115a and 120a, for example, 65 hertz. In at least one embodiment, the controller 105, for example, is enabled to share a resolution variable for the video output devices such that each video output device has a resolution of 800×600 dpi.

In step 410, the simulation software is preferably installed. For example, in at least one embodiment, the Star Trek simulation game “Star Trek: Judgment Rites,” manufactured by Interplay Entertainment Corporation, is installed to be executed by the CPU of the controller system 105. As another example, in at least one embodiment, the simulation game “Bridge Commander” available from Activision of Santa Monica Calif. After being presented with the disclosure herein, those of ordinary skill in the relevant art will realize that the present invention can be used in conjunction with a variety of types of simulation programs such as flight simulation programs, driving simulation programs, and simulation programs emulating sporting events.

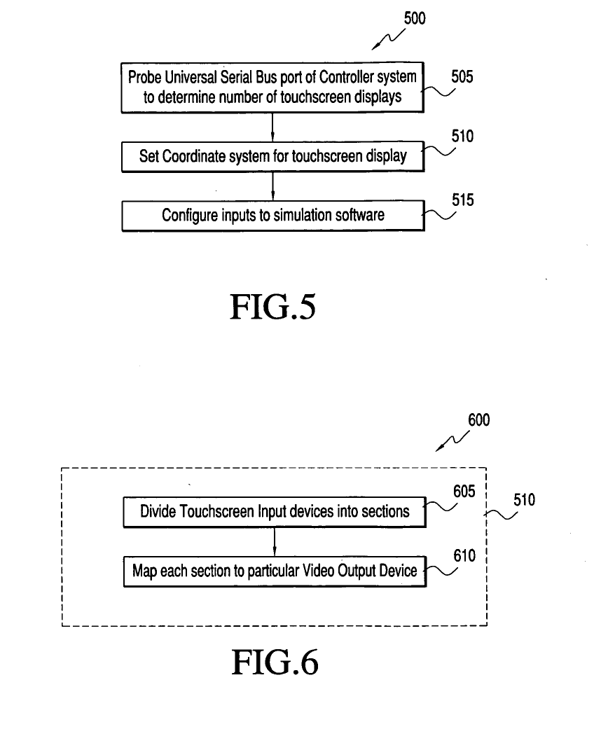

In step 415, a multiple monitor-touchscreen display driver is preferably installed. For example, in at least one embodiment, the driver is a computer program module including computer readable instructions for performing a routine that allows the system 100, for example, to accept multiple touchscreen inputs and provide multiple monitor outputs as will be described in more detail herein below in text accompanying FIG. 5.

In step 420, each touchscreen input device is preferably calibrated. For example, in at least one embodiment, the touchscreen input device 110b is calibrated with video output device 110a. Similarly, in such an embodiment, the touchscreen input device 115b is calibrated with video output device 115a. Finally, the touchscreen input device 120b is calibrated with video output device 120a.

In step 425, touchscreen computer software is preferably installed on each touchscreen input device. For example, in at least one embodiment, the Magic Touch® software identified above is installed on the touchscreen input device 110b, the touchscreen input device 115b, and the touchscreen input device 120b. As described above, the touchscreen computer software provides commands to the CPU executing the simulation program to instruct the various controllable parameters provided by the simulation program.

In step 430, display graphics are “drawn” on each touchscreen input device, as would be known to those of ordinary skill in the relevant art after being presented with the disclosure herein.

In step 435, input button commands on each touchscreen input device are isolated. For example, in at least one embodiment, the commands provided by the touchscreen computer software on a particular touchscreen input device, for example, input device 110b, are grouped as a sole group such that each group of commands has a specified function, for example, controlling a controllable parameter, in interacting with the simulation program executed by the CPU of the controller system 105.

In step 440, computer graphics are inserted into the touchscreen software as background. For example, in at least one embodiment of the invention, the touchscreen software does not activate a command if an area on the touchscreen input device is pressed, as the area includes only background graphics. Thus, these “dead” areas of the touchscreen input device are identified or defined in the touchscreen software.

In step 445, “hot” computer graphics are inserted into the touchscreen software as active areas. For example, in at least one embodiment, virtual buttons, levers, and/or alphanumeric letters on a virtual keyboard, or other graphics are inserted into the touchscreen software for each touchscreen input device. When such graphical features are activated, for example, a button is depressed, the touchscreen software preferably activates a command.

In step 450, the touchscreen software designates which commands are produced by alphanumeric input, for example, by activation of electronic keys on a virtual keyboard. In at least one embodiment, the time of duration for each electronic key is also designated. In such an embodiment, for example, if a “P” electronic key is pressed, the touchscreen software designates how long a specific command should be carried out, e.g., 30 seconds of a command simulating firing of torpedos.

In step 455, each simulation program parameter or element is instructed to accept input from a corresponding group of commands from a corresponding touchscreen input device.

In step 460, the simulation program is instructed to use one of the touchscreen input devices as the main viewer. In at least one embodiment, the main viewer displays surrounding graphics. It should be noted that as there are multiple video cards and the touchscreen input device software was originally designed to use the sole video card as the viewer, the simulation program should be instructed that each output should be displayed to a corresponding touchscreen input device.

Referring now to the exemplary method 500 in FIG. 5, illustrating an exemplary method performed by the driver installed in step 415 of FIG. 4 in at least one embodiment of the invention, in step 505, a Universal Serial Bus (USB) port of the controller system 105, for example, is probed to determine the number of touchscreen input devices. For example, it may be determined that there are three touchscreen input devices attached to the USB port of the controller system 105.

In step 510, a coordinate system for each touchscreen input device identified in step 505 is configured. For example, in at least one embodiment, although it has been determined in step 505 that there are a plurality of touchscreen input devices attached to the controller system 105's USB port, the plurality of touchscreen input devices are viewed as one unitary touchscreen input device wherein each section of the unitary touchscreen input device, that is, one of the touchscreen input devices identified in step 505, has a coordinate system.

In step 515, for each touchscreen input device forming the unitary device, input commands pertaining to the particular touchscreen input device are configured to interact with the simulation software.

Referring now to exemplary method 600 of FIG. 6, an exemplary method for performing step 510 of FIG. 5, in at least one embodiment, the coordinate system for each touchscreen input device is configured by assigning each touchscreen input device as a coordinate section of the unitary device identified in step 510. For example, referring again to FIG. 1, the touchscreen input device 110b is assigned as coordinate section A of the unitary device in at least one embodiment. The touchscreen input device 115b is assigned as coordinate section B of the unitary device in such an embodiment. Likewise, the touchscreen input device 120b is assigned as coordinate section C of the unitary device in such an embodiment.

In step 610, each of the assigned sections of the unitary device is mapped to a particular corresponding video output device. For example, coordinate section A is mapped to corresponding video output device 110a, and so forth for each coordinate section.

It should be noted that although the present invention has been presented in the context of being utilized with a game simulation program, the present invention may also be utilized in other scenarios such as with an educational simulation program, or any other viable type of simulation program.

Those skilled in the art will appreciate that various adaptations and modifications of the above-described embodiments can be configured without departing from the scope and spirit of the present invention. For example, in at least one embodiment, at least one projection screen can be utilized with the present invention. Therefore, it is to be understood that, within the scope of the appended claims, the invention may be practiced and constructed other than as specifically described herein.

1. A computer system for executing a computerized simulation program for allowing at least two participants to interact with the simulation program as a team with an overall common team goal, comprising:
a plurality of touchscreen input devices wherein each device is adapted to provide at least one corresponding group of input commands to the system;
a controller system communicatively coupled to each of said devices, said controller system including a central processing unit for executing the simulation program and for accepting each of said at least one corresponding group of input commands to allow each group of input commands to have a graphical effect on a parameter or element provided by the simulation program;
a plurality of video output devices wherein each of said video output devices is communicatively coupled to said controller system and corresponds to a particular touchscreen input device, each of said video output devices adapted to display output represented by a graphical effect on said parameter caused by a group of input commands; and
a multiple video output device-touchscreen input device driver module adapted to be executed on said controller system for allowing said groups of input commands to be accepted by said central processing unit.

2. The computer system of claim 1, wherein said controller system is a personal computer system.

3. The computer system of claim 1, wherein the simulation program is a game simulation program.

4. The computer system of claim 1, wherein each of said plurality of touchscreen input devices includes an on-screen keyboard.

5. The computer system of claim 1, wherein said video output device is a computer monitor.

6. The computer system of claim 1, wherein each of said touchscreen input devices includes onscreen keyboard software for providing said commands.

7. The computer system of claim 3, wherein a first game participant stationed at a first corresponding touchscreen input device/video output device pair controls a first parameter by instructing said touchscreen input device in said first pair to transmit a first group of commands, thereby affecting said first parameter.

8. The computer system of claim 7, wherein a second game participant stationed at a second corresponding touchscreen input device/video output device pair controls a second parameter by instructing said touchscreen input device in said second pair to transmit a second group of commands, thereby affecting a second parameter.

9. The computer system of claim 8, wherein a third game participant stationed at a third corresponding touchscreen input device/video output device pair controls said second parameter in addition to controlling a third parameter.

10. The computer system of claim 7, wherein a graphical effect on said first parameter is displayed on said video output device of said first pair.

11. The computer system of claim 10, wherein a graphical effect on a second parameter is displayed on a video output device in a second corresponding touchscreen input device/video output device pair.

12. The computer system of claim 11, wherein said graphical effect on said second parameter is also displayed on said video output device of said first pair.

13. A method performed by said multiple video output device-touchscreen input device driver module of claim 1, comprising:
probing a universal serial bus port of said controller system to determine a number of touchscreen input devices;
setting a coordinate system for each of said touchscreen input device; and
configuring all groups of said input commands to interact with said simulation program.

14. The method of claim 7, wherein said setting step includes:
dividing each of said touchscreen input devices into a section of a virtual unitary touchscreen input device; and
mapping each said section to a particular video output device.

15. A method for configuring the system of claim 1, comprising:
calibrating said touchscreen input devices to correspond to said video output devices;
isolating said input commands; and
instructing each said parameter to accept input from said touchscreen input devices.

16. The method of claim 15, further comprising designating which of said commands includes alphanumeric input.

17. The method of claim 16, further comprising designating duration of activation of said commands.
